(19) United States
(12) Patent Application Publication
(10) Pub. No.: US 2006/0083586 A1
(43) Pub. Date: Apr. 20, 2006

(54) Connecting joint arrangement

(75) Inventors: Christian Fuller, Grafenrheinfeld (DE); Martin Eichhorn, Sennfeld (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG

(21) Appl. No.: 11/233,973

(22) Filed: Sep. 23, 2005

(30) Foreign Application Priority Data
Sep. 24, 2004 (DE) 10 2004 046 682.3

(51) Int. Cl. F16D 1/00

(52) U.S. Cl. 403/408.1

(57) ABSTRACT

A connecting joint arrangement connectable between two assemblies that are free to move with respect to each other, the arrangement comprises a connecting element, a pin joint, and a support element having a support body. The support body is connectable to one of the two assemblies by a working connection including the connecting element and the pin joint. The connecting element has a pivot bearing for receiving a pivot bearing support element on the assembly to be supported. Although it is offset from the pin joint, the pivot bearing is functionally in series to the pin joint.

### BACKGROUND OF THE INVENTION

1. Field of the Invention

The invention relates to a connecting joint arrangement. More particularly, the invention relates to a connecting joint arrangement for connecting two assemblies such as the body of a vehicle and the vehicle axle that must be free to move with respect to each other.

2. Description of the Related Art

In axle elements such as vibration dampers or pneumatic springs or combinations of the two, connecting joint arrangements are used to allow the wheel and/or the axle to move in any direction relative to the body of the vehicle.

German Patent No. 197 55 549 C2 shows a pneumatic spring in combination with a vibration damper. The piston rod of the vibration damper is connected to a connecting plate by a pin joint. The connecting plate in turn is connected rigidly to the element to be supported, e.g., the vehicle body or the driver's compartment. The universal mobility is produced entirely by the pin joint, which has a spring sleeve, which is mounted axially under tension on the piston rod and is supported above and below the connecting plate. The spring sleeve must absorb not only the axial forces but also transverse forces. In the effort to design spring sleeves of this type, therefore, there is a conflict between the goal of absorbing forces and the goal of ensuring a comfortable ride.

German Patent No. 100 03 045 C2 discloses a pneumatic spring in combination with a vibration damper. The piston rod of the damper is rigidly connected to the cap of the pneumatic spring and has a pivot bearing connecting it to the component to be damped. A pivot bearing of this type is advantageous especially with respect to angular movements within a defined plane. To a lesser extent there is also some angular mobility in an axis transverse to the pivot bearing.

### SUMMARY OF THE INVENTION

An object of the present invention is to realize a connecting joint arrangement which offers an especially comfortable ride and a wide variety of design possibilities with respect to the mobility of the joint.

The object is accomplished according to the invention in that at least one pivot bearing is assigned functionally in series to the pin joint.

The great advantage of the invention is that the individual advantages of both the pin joint and the pivot bearing, at least one of which is provided, are available for use. In addition, the combination of the individual joints provides a highly effective, spring-loaded connecting joint arrangement. Thus the pin joint is intended to permit primarily vertical elastic movements, whereas the pivot bearing, which allows the pivoting movements, ensure that these movements take place with the least possible friction. The purpose of a conventional pin joint, in contrast, is to allow movement in all possible directions, whereas the pivot joints used in vehicle bodies are also expected to provide some elasticity in the vertical direction.

In an additional advantageous embodiment, the pin joint is offset from at least one pivot bearing. This leads to a compact design.

As a result, tilting moments which could act on the support element can be avoided, the pivot axis of the pivot bearing intersects the main axis of the pin joint.

With the goal of obtaining a simple and compact design, the connecting element carries at least one pivot bearing.

Alternatively, it is possible for the connecting element to carry at least one pivot bearing support element. For example, the pivot bearings themselves can be mounted on the assembly to be supported, and the pivot bearing support elements can have retaining bolts, which conduct the force from the connecting element via the pivot bearing to the assembly to be supported.

It has been found to be favorable for the pivot bearing support element to be designed as a U-shaped bracket, which holds the pivot bearing.

To limit the angular mobility of the pin joint as much as possible, the connecting element according to the invention has a spacer sleeve section for the spring bodies of the pin joint. The spacer sleeve section carries two spring bodies a certain distance apart. The gap between them does not cause any change in the spring rate in the axial direction, but the range of angular movement they allow is much smaller than that of a pin joint without a spacer sleeve section.

According to an advantageous embodiment, the connecting element has a receptacle for the pin joint. In the case of a support element designed as a pneumatic spring, the pin joint can also have a sealing function. The overall design of the connecting element is therefore quite simple.

In another advantageous embodiment, an annular gap is present between the connecting element and the support body of the support element. This annular gap determines the universal mobility of the pin joint independently of the spring rate of the spring bodies of the pin joint.

A radially elastic ring is inserted into the annular gap to center the pin joint radially with respect to the connecting element. The spring rate of the elastic ring represents another parameter which is available for adjusting the universal mobility of the pin joint.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 shows a cross section of a connecting joint arrangement in conjunction with a pneumatic spring as support element;

FIG. 2 shows a perspective view of the arrangement of FIG. 1;

FIG. 3 shows a cross-sectional view of the connecting joint arrangement with limited universal mobility; and

FIG. 4 shows a perspective view of the arrangement of FIG. 3.

### DETAILED DESCRIPTION OF THE PRESENTLY PREFERRED EMBODIMENTS

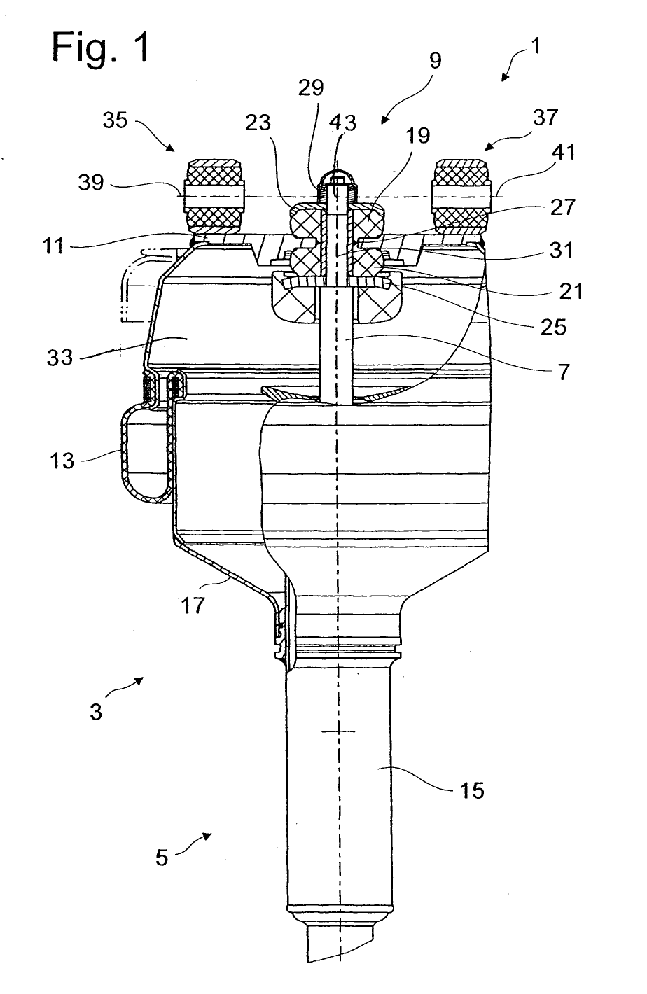

FIG. 1 shows a cross section through a connecting joint arrangement 1 in combination with a pneumatic spring as the support element 3, located between two assemblies which must be free to move with respect to each other, e.g., a vehicle axle and a vehicle body. The support element comprises a vibration damper 5 known in and of itself with an axially movable piston rod 7 as the support body. The support body is in working connection with a connecting element 11 by the use of a pin joint 9. The pneumatic spring is formed by the connecting element, by a roll-type bellows 13, and by a roll-down tube 17, attached to the cylinder 15 of the vibration damper 5.

The pin joint 9 comprises two ring-shaped spring bodies 19, 21, each of which is covered on one side by a cover disk 23, 25. The connecting element 11 has a receptacle 27 for the pin joint 9 and extends between the spring bodies 19, 21. The piston rod 7 thus has a certain limited freedom to execute angular movement with respect to the connecting element 11. A screwed joint 29 keeps the pin joint under axial pretension. The spring bodies also allow the piston rod to move elastically on the main axis of the pin joint, which coincides with the longitudinal axis of the piston rod. A spring space 33 of the pneumatic spring is formed by the connecting element, by the bellows 13, and by the roll-down tube 17; this space is sealed off in a pressure-tight manner by the pin joint 9.

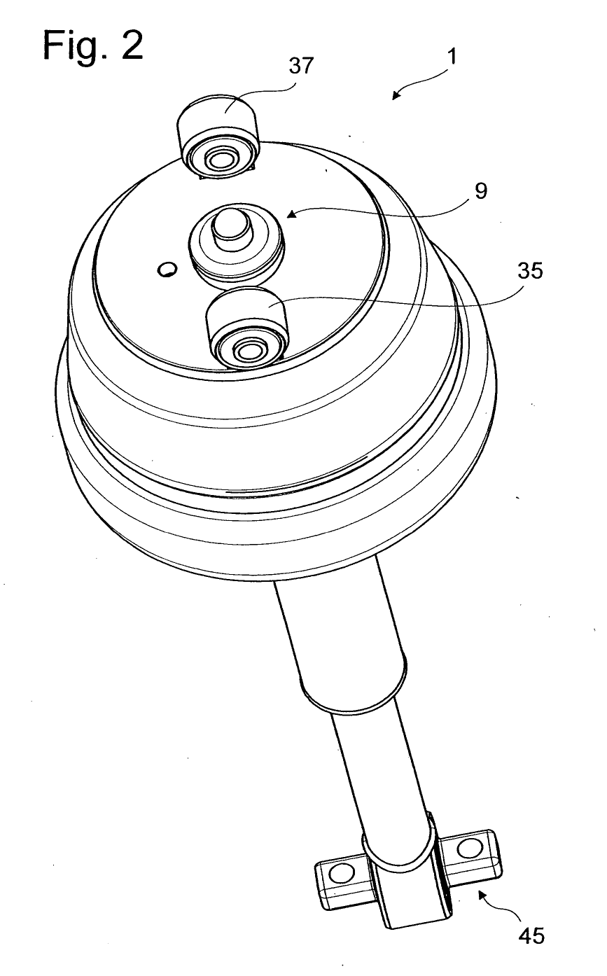

The connecting joint arrangement 1 also has at least one pivot joint element such as a pivot bearing 35, 37, which is assigned functionally in series to the pin joint 9. The main axis 31 of the pin joint 9 is spatially offset from at least one pivot bearing 35, 37, so that the overall arrangement is compact in the area of the individual bearings. In the exemplary embodiment, two pivot bearings 35, 37 are used, the pivot axes 39, 41 of which intersect the main axis 31 of the pin joint 9 at 43. This feature is clear upon joint consideration of FIGS. 1 and 2. The pivot bearings 35, 37, furthermore, are carried or mounted on the top of the connecting element 11. A retaining-bolt connection (not shown) is present between the pivot bearings and the assembly to be supported.

When the support element moves elastically and thus a lower connecting element 45 executes movement in space relative to the connecting joint arrangement 1, the pivot bearings 35, 37 will handle the component of the movement oriented around the pivot axes 39, 41, whereas the pin joint 9 will execute defined vertical movement. Because the three-dimensional movement is split into its components within the connecting joint arrangement, the spring rates and travels can be adjusted independently of each other to meet the desired criteria.

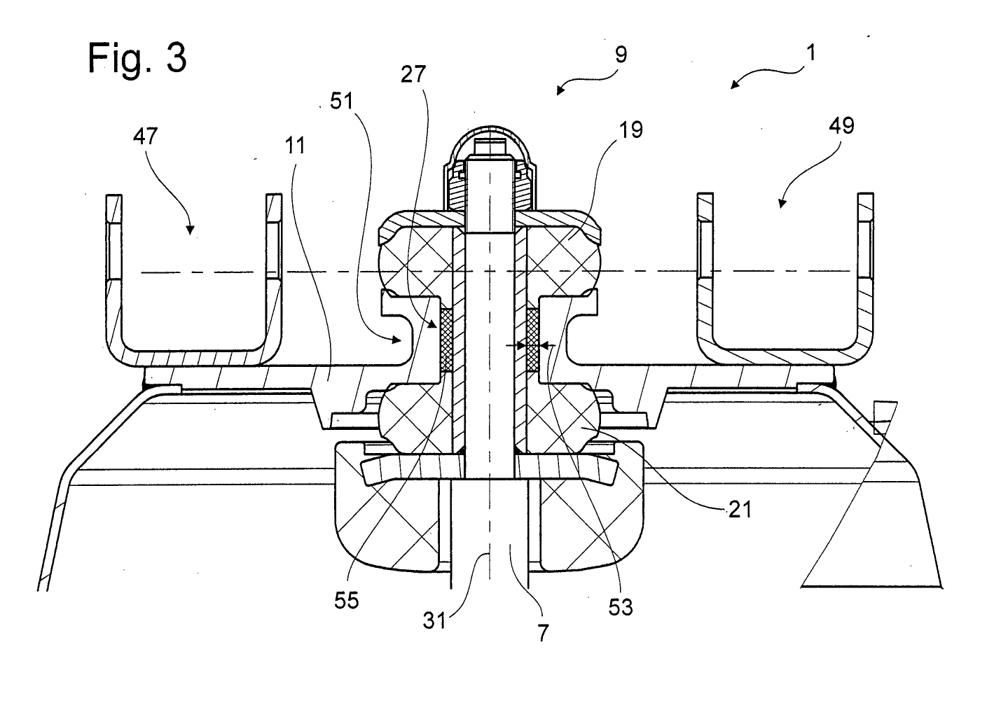

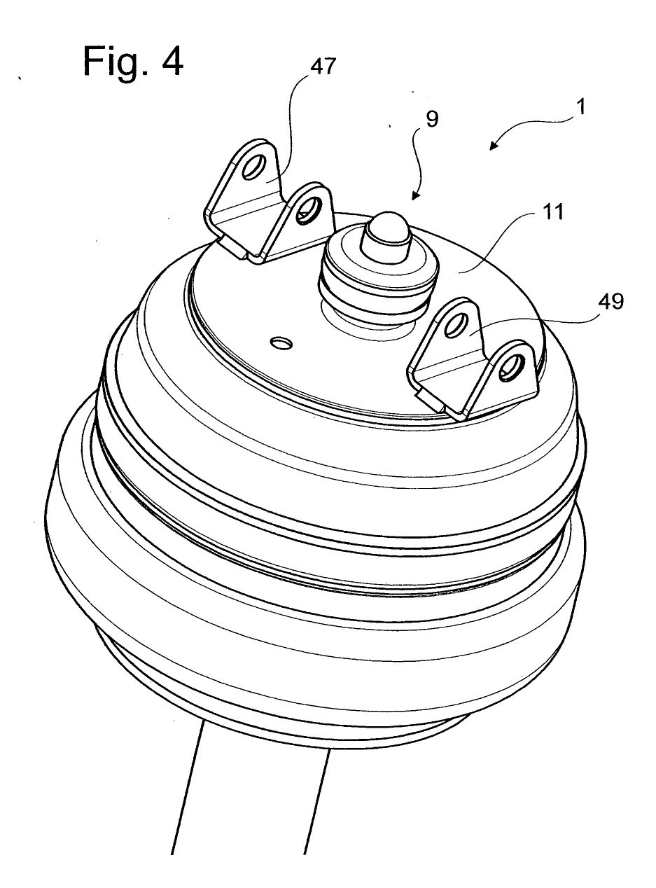

FIGS. 3 and 4 show a modification of the connecting joint arrangement shown in FIGS. 1 and 2. Here, the pivot bearings 35, 37 are replaced by pivot joint elements such as pivot bearing support elements 47, 49 in the form of U-shaped brackets, which are mounted on the connecting element. The pivot bearings themselves are carried or mounted on the assembly to be supported.

FIG. 3 discloses yet another inventive solution, which can also be used independently of a pin joint 9 arranged in series with at least one pivot bearing 35, 37.

As already explained in conjunction with FIG. 1, the connecting element 11 has a receptacle 27 for the pin joint 9. The receptacle 27 is formed by a spacer sleeve section 51 of the connecting element 11, which holds the spring bodies 19, 21 much farther apart than in the design according to FIG. 1. In addition, an annular gap 53 is present between the piston rod 7 or support body and the receptacle 27. The width of the annular gap, the distance between the spring bodies, and the spring rates of the spring bodies are available as parameters which can be used to determine effectively the limited angular mobility of the pin joint 9. It is also possible to provide very soft elastic support in the direction of the main axis 31 of the pin joint 9.

In addition, a ring 55 with elasticity at least in the radial direction can be installed in the annular gap 53 between the support body 7 and the connecting element 11. Through the choice of material, yet another parameter is made available for the determination of the angular mobility of the pin joint 9.

Thus, while there have shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A connecting joint arrangement connectable between two assemblies which are free to move with respect to each other, the arrangement comprising:
a support element having a support body;
a connecting element;
a pin joint,
wherein the support body is connectable to one of the two assemblies by a working connection including the connecting element and the pin joint; and
a pivot bearing mounted on the connecting element, the pivot bearing being functionally in series to the pin joint when the connecting joint arrangement is connected to the two assemblies.

2. The connecting joint arrangement of claim 1, wherein the pin joint has a main axis which is spatially offset from the pivot bearing.

3. The connecting joint arrangement of claim 2, wherein the pivot bearing has a pivot axis which intersects the main axis of the pin joint.

4. The connecting joint arrangement of claim 1, wherein the pin joint has two spring bodies, and wherein the connecting element has a spacer sleeve section for spacing the two spring bodies of the pin joint.

5. The connecting joint arrangement of claim 1, wherein the connecting element has a receptacle for the pin joint.

6. The connecting joint arrangement of claim 5, wherein there is an annular gap between the receptacle of the connecting element and the support body of the support element.

7. The connecting joint arrangement of claim 6, further comprising a radially elastic ring which is placed in the annular gap.

8. A connecting joint arrangement connectable between two assemblies which are free to move with respect to each other, the arrangement comprising:
a support element having a support body;
a connecting element;
a pin joint,
wherein the support body is connectable to one of the two assemblies by a working connection including the connecting element and the pin joint; and
a pivot bearing support element mounted on the connecting element, the pivot bearing support element being functionally in series to the pin joint when the connecting joint arrangement is connected to the two assemblies.

9. The connecting joint arrangement of claim 8, wherein the pivot bearing support element is a U-shaped bracket for receiving a pivot bearing on one of the assemblies.

10. The connecting joint arrangement of claim 8, wherein the pin joint has a main axis which is spatially offset from the pivot bearing support element.

11. The connecting joint arrangement of claim 10, wherein the pivot bearing support element has a pivot axis which intersects the main axis of the pin joint.

12. The connecting joint arrangement of claim 8, wherein the pin joint has two spring bodies, and wherein the connecting element has a spacer sleeve section for spacing the two spring bodies of the pin joint.

13. The connecting joint arrangement of claim 8, wherein the connecting element has a receptacle for the pin joint.

14. The connecting joint arrangement of claim 13, wherein there is an annular gap between the receptacle of the connecting element and the support body of the support element.

15. The connecting joint arrangement of claim 14, further comprising a radially elastic ring which is placed in the annular gap.

16. A connecting joint arrangement connectable between connecting two assemblies which are free to move with respect to each other, the arrangement comprising:
a support element having a support body and a main axis;
a pin joint having two spring bodies;
a connecting element having a receptacle for receiving at least part of the spring bodies of the pin joint, the receptacle having a spacer sleeve section for spacing the two spring bodies of the pin joint,
wherein the support body is connectable to one of the two assemblies by a working connection including the connecting element and the pin joint, and wherein there is an annular gap between the receptacle of the connecting element and the support body of the support element;
a radially elastic ring placed in the annual gap; and
a pivot joint element mounted on the connecting element, the pivot joint element being spatially offset from and functionally in series to the pin joint when the connecting joint arrangement is connected to the two assemblies.

17. The connecting joint arrangement of claim 16, wherein the pivot joint element is a pivot bearing.

18. The connecting joint arrangement of claim 16, wherein the pivot joint element is a U-shaped bracket.
